(19) United States
(12) Patent Application Publication
(10) Pub. No.: US 2021/0027173 A1
(43) Pub. Date: Jan. 28, 2021

(54) INDICATOR DETERMINING METHOD AND RELATED DEVICE

(71) Applicant: HUAWEI TECHNOLOGIES CO., LTD., Shenzhen (CN)

(72) Inventors: Wei SONG, Nanjing (CN); Zhenwei ZHANG, Nanjing (CN)

(21) Appl. No.: 17/032,779

(22) Filed: Sep. 25, 2020

Related U.S. Application Data
(63) Continuation of application No. PCT/CN2019/076124, filed on Feb. 26, 2019.

(30) Foreign Application Priority Data
Mar. 26, 2018 (CN) 201810260956.3

(51) Int. Cl. G06N 5/02; G06N 20/20; G06N 20/10

(52) U.S. Cl. CPC G06N 5/02; G06N 20/10; G06N 20/20

(57) ABSTRACT

Embodiments of this disclosure provides an indicator determining method and a related device, to predict KQI results of different services by using a network KPI parameter. The method of the embodiments of this disclosure includes: obtaining to-be-predicted data of a service, where the to-be-predicted data includes a key performance indicator KPI of a network in which the service is located and a type identifier of the service, and the type identifier is indicative of a type of the service; determining, based on the type identifier, a target predictive model in a predictive model set, where the predictive model set includes at least one predictive model, and each predictive model in the predictive model set corresponds to one service type; and determining, based on the target predictive model and the KPI in the to-be-predicted data, a key quality indicator KQI of the service.

### CROSS-REFERENCE TO RELATED APPLICATIONS

This application is a continuation of International application No. PCT/CN2019/076124, filed on Feb. 26, 2019, which claims priority to Chinese Patent Application No. 201810260956.3, filed on Mar. 26, 2018. The disclosures of the aforementioned applications are hereby incorporated by reference in their entireties

### TECHNICAL FIELD

This disclosure relates to the field of data analysis, and in particular, to an indicator determining method and a related device.

### BACKGROUND

A network key performance indicator (KPI) is an indicator used to measure network performance, including a speed rate, a bandwidth, a latency, a packet loss rate, a throughput rate, and the like. A key quality indicator (KQI) is a service quality parameter focusing on user experiences for different services.

In a common system, a user experience result of a service run on an application is usually represented by the KQI. A reason why user experience results of the service are different may be a defect of a design of the application, or may be freezing, instability, and the like of a network connected to the service. Therefore, a network status of the network connected to the service also becomes one of the parameters that evaluate user experience. In an existing training model, a KQI is predicted by analyzing network KPI data. The training model can be generated by collecting a large amount of KPI data, and a larger data volume generally indicates a more accurate result of the training model.

However, in an existing solution in which the network KPI is associated to a service KQI by using a machine learning method, the service KQI is considered merely from a perspective of the network KPI, and precision of the KQI obtained by predicting by the training model is limited.

### SUMMARY

Embodiments of this disclosure provides an indicator determining method and a related device, to predict KQI results of different services by using a network KPI parameter.

According to an embodiment of this disclosure, an indicator determining method is provided. The method includes:

obtaining to-be-predicted data of a service, where the to-be-predicted data includes a KPI parameter of a network in which the service is located and a type identifier of the service, and the KPI parameter of the network in which the service is located is KPI data of the network to which the service is connected.

The KPI data of the network includes at least one of the following parameters: a time of the network, signal strength, a packet loss rate, a channel utilization rate, a media access control MAC address of a network device, a terminal vendor, a MAC address of a terminal, a latency, a jitter, a negotiated sending rate, a sending rate, a receiving rate, and a negotiated receiving rate.

The type identifier of the service may indicate a type of the service, such as a video service, a voice service, a multimedia service, or the like, and the video service, the voice service and the multimedia service have different identifiers.

Subsequently, a target predictive model is determined, based on the type identifier of the service, in a predictive model set. Because different service types correspond to different predictive models, the predictive model set includes at least one predictive model, and each predictive model corresponds to one service type.

The KPI in the to-be-predicted data is substituted in the target predictive model, to obtain a KQI result of the service.

An embodiment of this disclosure has the following advantages: An analysis apparatus obtains the to-be-predicted data of the service, where the to-be-predicted data includes the service type identifier of the service, and the service type identifier may indicate a target service type of the service. Then the analysis apparatus determines the target predictive model based on the target service type of the service, and determines the key quality indicator KQI of the service by using the target predictive model. In this embodiment of this disclosure, when the KQI of the service is predicted by using the network KPI parameter, it is considered that services of different service types have different predictive models, so that the KQI result of the service predicted by using the network KPI parameter is more accurate.

In an embodiment, before the determining, based on the type identifier of the service, a target predictive model in a predictive model set, the method further includes:

obtaining a sample data set, where the sample data set includes at least one piece of sample data, and each piece of sample data in the sample data set includes the KPI of the network in which the service is located;

determining a service KQI corresponding to each piece of sample data in the sample data set;

generating a first training record based on the sample data set of the service and the service KQI corresponding to each piece of sample data in the sample data set; and

generating the target predictive model by training a model based on the first training record, and adding the target predictive model to the predictive model set.

In an embodiment, a training process of the target predictive model is described, to increase feasibility of the solution.

In an embodiment, the generating the target predictive model based on the first training record includes:

separately determining, based on the first training record, weight coefficients of a support vector machine SVM model, a random forest model, and a logistic regression model in the target predictive model.

In an embodiment, the weight coefficients of the support vector machine SVM model, the random forest model, and the logistic regression model in the target predictive model are referred to as, after the support vector machine SVM model, the random forest model, and the logistic regression model generate KQI values based on the to-be-predicted KPIs, a percentage of a KQI result value determined by each model in a KQI result value determined by the target predictive model.

Subsequently, the target predictive model is generated based on the weight coefficients of the support vector machine SVM model, the random forest model, and the logistic regression model in the target predictive model.

In an embodiment, a percentage status of the support vector machine SVM model, the random forest model, and the logistic regression model in the target predictive model is described, to increase feasibility of the solution.

Based on the first implementation and the second implementation of the first aspect, in a third implementation of the first aspect, the sample data set includes first sample data, second sample data, and third sample data, a first KQI corresponding to the first sample data is less than a second KQI corresponding to the second sample data, the second KQI corresponding to the second sample data is less than a third KQI corresponding to the third sample data, and data volumes of the first sample data, the second sample data, and the third sample data are equal.

In an embodiment, a sampling manner for the sample data is described, to increase reasonability of solution implementation.

In an embodiment, the sample data set includes fourth sample data, and a fourth KQI corresponding to the fourth sample data is less than a preset KQI threshold.

In an embodiment, sample data with a low KQI is collected by restricting the fourth KQI to be less than the preset KQI threshold, and low KQI means that the KQI result is poor.

In an embodiment, another sampling manner for the sample data is described, to increase flexibility of solution implementation.

Based on an embodiment, the weight coefficients of the SVM model, the random forest model, and the logistic regression model in the target predictive model are respectively X, Y and Z, and a result value Q predicted by the target predictive model=X*a result value predicted by the SVM model+Y*a result value predicted by the random forest model+Z*a result value predicted by the logistic regression model.

In an embodiment, an algorithm used by the target predictive model to predict the result value is described, to increase integrity of the solution.

Based on an embodiment, the type of the service is a video service, the result value Q predicted by the target predictive model=x1*the result value predicted by the SVM model+y1*the result value predicted by the random forest model+z1*the result value predicted by the logistic regression model, and x1>y1>z1.

In an embodiment, in a possible case in which the type of the service is the video service, a percentage of the result value predicted by the SVM model in the total result value of the target predictive model is the greatest.

In an embodiment, this embodiment is described with reference to a specific application scenario, to increase feasibility of the solution.

Based on an embodiment, the type of the service is a voice service, the result value Q predicted by the target predictive model=x2*the result value predicted by the SVM model+y2*the result value predicted by the random forest model+z2*the result value predicted by the logistic regression model, and y2>x2>z2.

In an embodiment, in a possible case in which the type of the service is the voice service, a percentage of the result value predicted by the random forest model in the total result value of the target predictive model is the greatest.

In an embodiment, this embodiment is described with reference to another specific application scenario, to increase flexibility of solution implementation.

Based on an embodiment, the result value Q predicted by the target predictive model=x3*the result value predicted by the SVM model+y3*the result value predicted by the random forest model+z3*the result value predicted by the logistic regression model, and z3>y3>x3.

In an embodiment, in a possible case in which the type of the service is the multimedia service, a percentage of the result value predicted by the logistic regression model in the total result value of the target predictive model is the greatest.

In an embodiment, this embodiment is described with reference to another specific application scenario, to increase flexibility of solution implementation.

Based on the method according to an embodiment, after the determining, based on the target predictive model and the KPI in the to-be-predicted data, a key quality indicator KQI of the service, the method further includes:

generating the KQI result after inputting the to-be-predicted data into the target predictive model, and generating a second training record by recording the to-be-predicted data and the corresponding KQI result; and

adjusting a target predictive model parameter based on the second training record and a KQI value of the to-be-predicted data in an actual case.

In this embodiment, an optimization process of the target predictive model is described, to make the predicted result of the target predictive model more accurate.

According an embodiment this disclosure, an analysis apparatus is provided. The analysis apparatus includes:

an obtaining unit, configured to obtain to-be-predicted data of a service, where the to-be-predicted data includes a key performance indicator KPI of a network in which the service is located and a type identifier of the service, and the type identifier is used to indicate a type of the service; and

a determining unit, configured to determine, based on the type identifier, a target predictive model in a predictive model set, where the predictive model set includes at least one predictive model, each predictive model in the predictive model set corresponds to one service type, and

the determining unit is further configured to determine, based on the target predictive model and the KPI in the to-be-predicted data, a key quality indicator KQI of the service.

In an embodiment, when the KQI of the service is predicted by using the network KPI parameter, it is considered that services of different service types have different predictive models, so that the KQI result of the service predicted by using the network KPI parameter is more accurate.

Based on an embodiment, the analysis apparatus further includes a generation unit.

The obtaining unit is further configured to obtain a sample data set of the service, where the sample data set includes at least one piece of sample data, and each piece of sample data in the sample data set includes the KPI of the network in which the service is located.

The generation unit is configured to: determine a service KQI corresponding to each piece of sample data in the sample data set, generate a first training record based on the sample data set of the service and the service KQI corresponding to each piece of sample data in the sample data set, generate the target predictive model based on the first training record, and add the target predictive model to the predictive model set.

In an embodiment, a training process of the target predictive model is described, to increase feasibility of the solution.

Based on an embodiment, when generating the target predictive model based on the first training record, the generation unit is configured to:

separately determine, based on the first training record, weight coefficients of a support vector machine SVM model, a random forest model, and a logistic regression model in the target predictive model; and

generating the target predictive model based on the weight coefficients of the support vector machine SVM model, the random forest model, and the logistic regression model in the target predictive model.

In an embodiment, a generation process of the target predictive model is described, to increase integrity of solution implementation.

Based on an embodiment, the analysis apparatus further includes an update unit.

The generation unit is further configured to generate a second training record of the KPI in the to-be-predicted data and the key quality indicator KQI corresponding to the KPI in the to-be-predicted data.

The update unit is configured to update the target predictive model based on the second training record.

In an embodiment, a process in which the to-be-predicted data is reversed as the sample data to update the model is described, to optimize the target predictive model.

According to an embodiment of this disclosure, an analysis apparatus is provided. The analysis apparatus includes a memory and a processor.

The memory is configured to store a program and an instruction.

The processor is configured to invoke the program and the instruction in the memory, to perform the method according to the first aspect and any implementation of the first implementation to the ninth implementation of the first aspect.

According to an embodiment this disclosure, a computer-readable storage medium is provided. The computer-readable storage medium stores an instruction, and when the instruction is run on a computer, the computer is enabled to perform the methods according to the foregoing aspects.

According to an embodiment this disclosure, a computer program product including an instruction is provided, and when the computer program product is run on a computer, the computer is enabled to perform the methods according to the foregoing aspects.

### BRIEF DESCRIPTION OF DRAWINGS

FIG. 1a is a schematic structural diagram of an analysis apparatus according to this disclosure.

FIG. 1b is another schematic structural diagram of an analysis apparatus according to this disclosure.

FIG. 1c is another schematic structural diagram of an analysis apparatus according to this disclosure.

FIG. 1d is another schematic structural diagram of an analysis apparatus according to this disclosure.

FIG. 1e is another schematic structural diagram of an analysis apparatus according to this disclosure.

FIG. 2a is a schematic diagram of an embodiment of an indicator determining method according to this disclosure.

FIG. 2b is a schematic diagram of another embodiment of an indicator determining method according to this disclosure.

FIG. 3 is a schematic diagram of an association relationship between a network KPI and a service KQI.

FIG. 4 is a schematic diagram of a sampling manner for sample data.

FIG. 5 is a schematic diagram of another embodiment of an indicator determining method according to this disclosure.

FIG. 6 is a schematic diagram of another embodiment of an indicator determining method according to this disclosure.

FIG. 7 is another schematic structural diagram of an analysis apparatus according to this disclosure.

FIG. 8 is another schematic structural diagram of an analysis apparatus according to this disclosure.

FIG. 9 is another schematic structural diagram of an analysis apparatus according to this disclosure.

### DESCRIPTION OF EMBODIMENTS

This disclosure provides an indicator determining method, to predict a service KQI based on a network KPI. The service KQI is mainly referred to as user experience of a service, and better user experience corresponds to a higher service KQI value. There are many factors affecting user experience. Internal factors of a user are uncontrollable factors, and those are not explored in this disclosure. External factors affecting user experience of the service mainly includes performance of user equipment. In addition, performance of a network used by the user is also an important factor. In this disclosure, a relationship between a network KPI parameter and a service KQI is established in a manner of model training. In this disclosure, indicator determining and model training are performed by an analysis apparatus.

In the embodiments of this disclosure, the analysis apparatus is an apparatus capable of data analysis, and the analysis apparatus may be a server or a terminal. There are several cases of a composition structure of the analysis apparatus below.

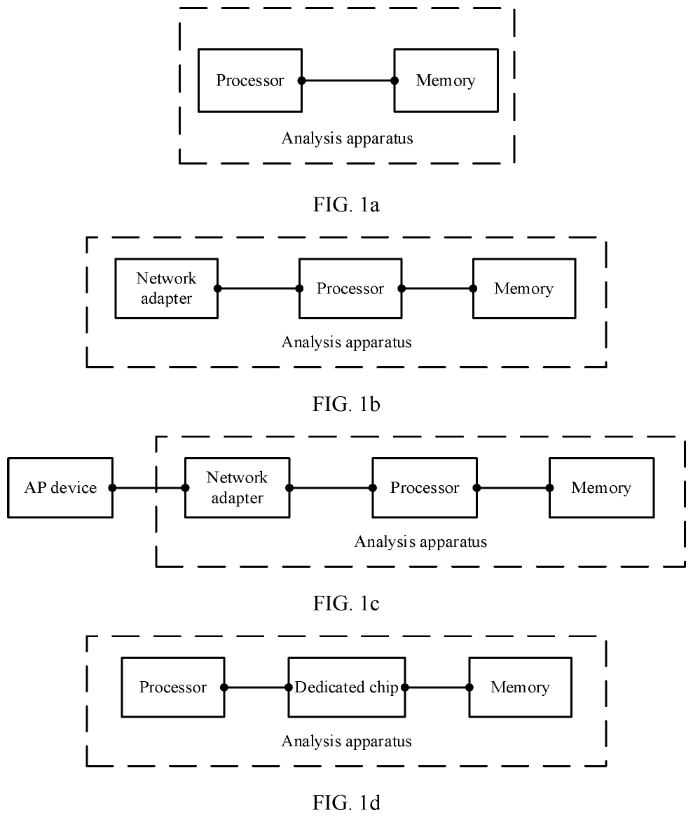

A: Referring to FIG. 1a, the analysis apparatus includes a processor and a memory, the processor is configured to generate a predictive model after analyzing and processing KPI data inputted by another device, and the memory is configured to store the predictive model.

B: Referring to FIG. 1b, the analysis apparatus includes a network adapter, a processor and a memory, the network adapter is configured to collect KPI data from a network side, the processor is configured to process the KPI data collected by the network adapter and generate a predictive model, and the memory is configured to store the predictive model.

C: Referring to FIG. 1c, a wireless access point (AP) is configured to connect a wireless network, and send network KPI data to the analysis apparatus, so that the analysis apparatus can perform an analyzing and processing block that is similar to the block shown in FIG. 1b.

D: Referring to FIG. 1d, the analysis apparatus includes a dedicated chip, a processor and a memory, the processor is configured to analyze and process inputted data to generate a predictive model, the dedicated chip is configured to accelerate the data processing procedure, where a time to generate the predictive model and a time to generate a predicted result by using the predictive model can be shortened by using the dedicated chip, and the memory is configured to store the predictive model. In this embodiment, the analysis apparatus may further include a network adapter. In this case, the data inputted into the processor can be obtained by the analysis apparatus. If the analysis apparatus does not include the network adapter, the data inputted into the processor is sent to the analysis apparatus after the data is obtained by another device.

In the analysis apparatuses shown in FIG. 1a to FIG. 1d, most of the memories are disks. In addition to the disks, the memory may alternatively be a memory of the analysis apparatus, and this is not limited herein.

E: Referring to FIG. 1e, the analysis apparatus and a storage device are different devices. The analysis apparatus includes a processor, and the processor stores, after processing inputted data and generating a predictive model, the predictive model in the storage device. In this case, the predictive model is stored in an independent storage device, and can be used by another device other than the analysis apparatus.

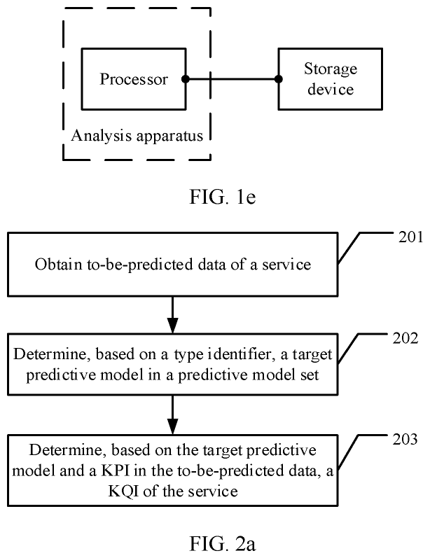

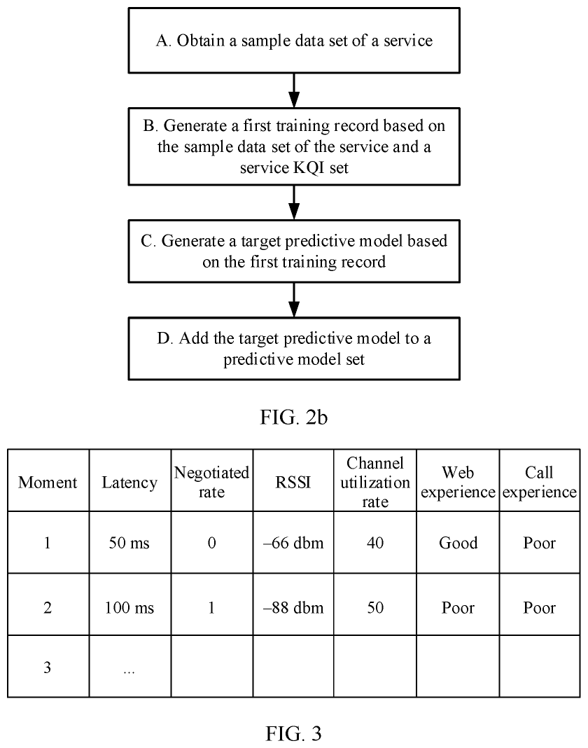

In this disclosure, when the analysis apparatus is analyzing and processing the network KPI data to predict the service KQI, a type of the service is further considered. There are different target predictive models for different types of services. Referring to FIG. 2a, an indicator determining method of this disclosure is described below.

201. Obtain to-be-predicted data of a service.

The to-be-predicted data of the service includes a key performance indicator KPI of a network to which the service is connected and a type identifier of the service, and the type identifier of the service may indicate a type of the service.

The KPI of the network includes at least one of the following parameters: a time, signal strength, a packet loss rate, a channel utilization rate, a media access control (MAC) address of a network device, a terminal vendor, a MAC address of a terminal, a latency, a jitter, a negotiated sending rate, a sending rate, a receiving rate and a negotiated receiving rate.

The type identifier of the service may be a code (for example, 001, 011, and the like) or a name of the service (for example, a video, a web page, a voice, and the like), and this is not specifically limited herein.

202. Determine, based on the type identifier, a target predictive model in a predictive model set.

As shown in FIG. 3, a network KPI includes a moment, a latency, a negotiated rate, a received signal strength indicator (RSSI), and a channel utilization rate. User experience of different service (for example, a web service and a call service) under a same network KPI is different. For example, in FIG. 3, for KPI data corresponding to a moment 1, web experience of a user is good, but calling experience of the user is poor. Therefore, when performing data analysis, the analysis apparatus determines different target predictive models for different types of services. There is a one-to-one correspondence between the predictive model and the service type. Because there are a plurality of types of services, the predictive models formed by the analysis apparatus are a set, and the analysis apparatus should determine, based on the type identifier of the service, the target predictive model in the trained predictive model set.

In this embodiment, the type of the service may be a multimedia service, a voice service, and a video service. The multimedia service may further be web page browsing, gaming, live broadcast, and the like, the voice service may be a voice call, and the video service may be an H.265 video, an MP4 video and a moving picture experts group (MPEG) video. The type of the service may further have more other cases, and this is not specifically limited herein.

A predictive model training process is a process of analyzing and calculating, by the analysis apparatus, sample data after obtaining the sample data. Referring to FIG. 2b, the process is described below.

A: Obtain a sample data set of the service, and determine a service KQI corresponding to each piece of sample data in the sample data set.

The sample data set includes at least one network KPI parameter. For example, in FIG. 3, the latency is 50 ms, the negotiated rate is 0, the RSSI is −66 dbm, and the channel utilization rate is 40. The series of network parameters form one network KPI in this embodiment of this disclosure.

Different network KPIs have different user experience, and have different KQI values. Therefore, each network KPI corresponds to a unique KQI, and the unique correspondence thereof includes the following two cases:

1. Each network KPI is in a one-to-one correspondence with each service KQI result. For example, a service KQI result generated by a network KPI is good, and a service KQI result generated by another network KPI is poor.

2. Different network KPIs correspond to a same KQI result. For example, a service KQI result generated by a network KPI is good, and a service KQI result generated by another network KPI is also good.

In a machine learning method in this embodiment, sample data collection for the predictive model should consider the following:

1. The collected sample data set includes fourth sample data.

In this embodiment, there are relatively few summaries about a network KPI corresponding to a low KQI, causing a large quantity of inaccurate prediction cases. Therefore, when data is collected, a case in which user experience is relatively poor should be considered, to ensure integrity and reliability of an established predictive model. For example, when the data is collected, many common fault models, for example, a series of network statuses such as a low signal, high interference, a large background flow, and the like, can be injected. Therefore, collection of the fourth sample data should be considered. A fourth KQI corresponding to the fourth sample data is less than a preset KQI threshold (that is, a critical value of a low KQI result that is determined by the analysis apparatus). The fourth sample data includes one or more pieces of KPI data, and a larger data volume indicates a more accurate predictive model.

2. The collected sample data set includes first sample data, second sample data, and third sample data.

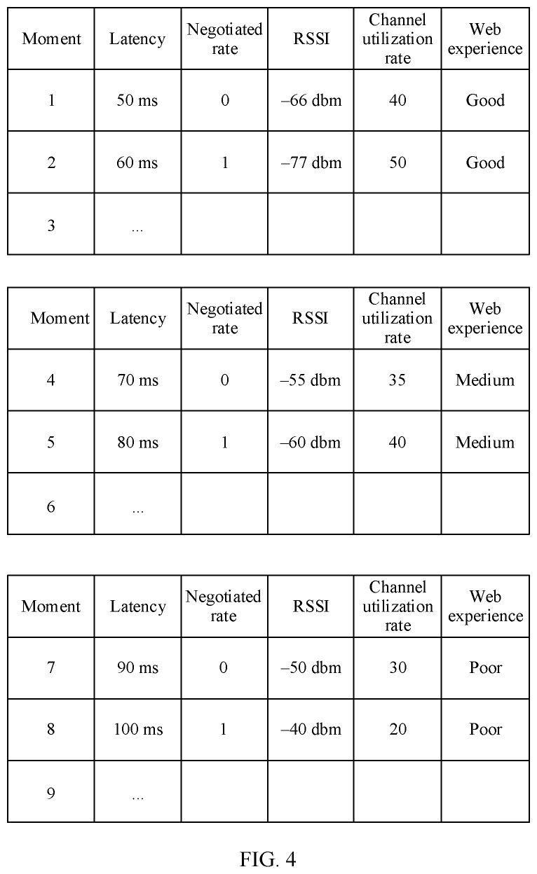

In a process of model training, in addition to the injection of many fault models in the solution, that is, collection of low KQI data, proportionality of data collection should be further considered. Therefore, in data collection, percentages of each data should be almost the same. Therefore, the obtained sample data includes the first sample data, the second sample data and the third sample data. A first KQI corresponding to the first sample data is less than a second KQI corresponding to the second sample data, and the second KQI corresponding to the second sample data is less than a third KQI corresponding to the third sample data. The third KQI may be a low KQI. Referring to FIG. 4, for example, in a process of generating a predictive model of a web browsing service, equal amounts of KPI data with good, medium and poor KQI results are separately obtained, to ensure proportionality of good, medium, and poor data, so that a predictable range of the predictive model is more comprehensive, and the result is more accurate.

B: Generate a first training record based on the sample data set of the service and a service KQI set.

The sample data set of the service and the KQI corresponding to each piece of sample data of the service are recorded to generate the first training record.

C: Generate the target predictive model based on the first training record.

In this embodiment, the target predictive model is a model obtained by training, by the analysis apparatus after obtaining the sample data of the service, the sample data. The analysis apparatus establishes, based on the first training record, an association relationship between a KPI parameter and a user experience KQI parameter, that is, the analysis apparatus determines an algorithm formula for the target predictive model.

D: Add the target predictive model to the predictive model set.

203. Determine, based on the target predictive model and the KPI in the to-be-predicted data, a KQI of the service.

The analysis apparatus performs service KQI prediction based on the determined target predictive model.

In this embodiment, the analysis apparatus generates a predictive model by analyzing network KPI data and service KQI data in a machine learning manner, and predicts the service KQI based on the network KPI data by using the predictive model.

In this embodiment, when the KQI of the service is predicted by using the network KPI parameter, it is considered that services of different service types have different predictive models, so that the KQI result of the service predicted by using the network KPI parameter is more accurate.

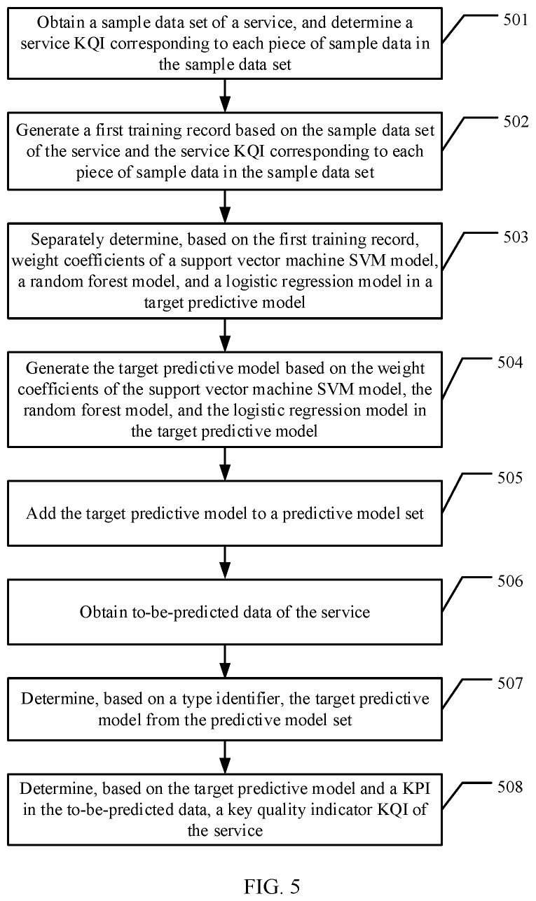

In the embodiments, the target predictive model is integration of three models. A result predicted by each of the three models has a particular weight coefficient in a predicted result value of the target predictive model, the weight coefficients are respectively denoted as X, Y and Z. A training process of the target predictive model is also a determining process for the weight coefficients X, Y and Z. In addition, algorithms of the foregoing three models are determined in the model training process. Referring to FIG. 5, the algorithms are described below.

501: Obtain a sample data set of a service, and determine a service KQI corresponding to each piece of sample data in the sample data set.

502: Generate a first training record based on the sample data set of the service and the service KQI corresponding to each piece of sample data in the sample data set.

In this embodiment, embodiment block 501 and block 502 are similar to embodiment block A and block B in block 202, and they are not specifically described herein again.

503. Separately determine, based on the first training record, weight coefficients of a support vector machine SVM model, a random forest model, and a logistic regression model in a target predictive model.

In this embodiment, in the training process of the target predictive model, the weight coefficients of the support vector machine SVM model, the random forest model, and the logistic regression model in the target predictive model should be determined, and the first training record should be separately substituted into the three types of models to obtain the algorithm formulas of the three types of models.

A fundamental principle of a support vector machine (SVM) model is: Given a sample set including a positive example and a negative example, an objective of the SVM is to find a hyperplane to segment a sample based on the positive example and the negative example. An algorithm formula of the support vector machine model is: g(x)=w^{T}x+b. The first training record is substituted into the SVM algorithm formula to obtain values of w and b through training. The values are made into constants, and the SVM algorithm formula becomes a function formula between a dependent variable g(x) and an independent variable x, x is used to indicate the KPI, and g(x) is used to indicate the KQI. Therefore, the SVM can predict, by using the network KPI, a KQI of an application.

A principle of the random forest model is: A random forest algorithm is based on a decision tree, a main idea thereof is to classify sample data with KQI predicted results good, medium and poor into three types, find a characteristic property of each type of data, and establish the decision tree. A process of performing KQI prediction by using the decision tree includes: testing, starting from a root node, a corresponding characteristic property in to-be-predicted KPI data, selecting an output branch based on a value of the characteristic property until reaching a leaf node, and using a type in which the leaf node is stored as a decision result, that is, a KQI result value.

A fundamental principle of logistic regression is: Positive samples and negative samples that have a same quantity are collected, and these samples are drawn. A line distinguishes the two types of samples, and the fitted curve is a regression curve. The model training process is a process of finding the line by using a large amount of data and fitting an expression of the line. New to-be-predicted data is classified by using the line. In this disclosure, the KPI data is classified into three types by using a method of simulating the regression curve, and corresponding KQI results are respectively good, medium, and poor. An algorithm formula of logistic regression is:

$$y = \frac{1}{1 + {e}^{- z}} ,$$

where z=w1*x1+w2*x2+w3*x3+ . . . +wn*xn, w is an undetermined parameter, x is a feature value of each dimension (for example, for a three-dimensional plane, the data x has three feature values) of the KPI data, and y is the obtained KQI result. Subsequently, these output results are compared with actual result values of the sample, and a parameter value of the fitted line (namely, the regression curve) is adjusted based on a comparison result, to optimize the parameter w of the fitted line and make the logistic regression model more accurate.

When the algorithm formulas of the three types of models are determined, the weight coefficients of the three types of models further should be determined.

504: Generate the target predictive model based on the weight coefficients of the support vector machine SVM model, the random forest model, and the logistic regression model in the target predictive model.

In this disclosure, an algorithm formula of the target predictive model after combination is: a result value Q predicted by the target predictive model=X*a result value predicted by the SVM model+Y*a result value predicted by the random forest model+Z*a result value predicted by the logistic regression model.

The model training process is described below with reference to specific application scenarios.

1. An analysis apparatus generates a predictive model for a video service.

The analysis apparatus first determines a network KPI parameter, and obtains a KQI result of the KPI parameter for the video service. A large quantity of KPI parameters and KQI results are obtained by repetitively performing this block. Therefore, an association relationship between the KPI parameter and the KQI result is found, and an algorithm formula of the predictive model is determined. The algorithm formula of the predictive model is: the result value Q predicted by the target predictive model=X*the result value predicted by the SVM model+Y*the result value predicted by the random forest model+Z*the result value predicted by the logistic regression model. By substituting a large amount of different KPI data and corresponding KQI predicted result values of the KPI data into the algorithm formula, it is obtained that parameters X=x1, Y=y1, and Z=z1, and X, Y and Z are made into fixed values, so that in a subsequent model prediction process, the KQI result value Q can be obtained by substituting the KPI data.

A possible case is that, for the video service, the percentage x1 of the predicted result of the SVM model in the total predicted result value is greater than the percentage y1 of the predicted result of the random forest model in the total predicted result value, and y1 is greater than the percentage z1 of the predicted result of the logistic regression model in the total predicted result value. That is, for the video service, the weight coefficient of the SVM model prediction result in the target predictive model is the greatest.

2. The analysis apparatus generates a predictive model for a voice service.

The analysis apparatus first determines a network KPI parameter, and obtains a KQI result of the KPI parameter for the voice service. A large quantity of KPI parameters and KQI results are obtained by repetitively performing this block. Therefore, an association relationship between the KPI parameter and the KQI result is found, and an algorithm formula of the predictive model is determined. It is obtained that the parameters X=x2, Y=y2, and Z=z2. A determining process of the parameters in the algorithm formula of the predictive model is similar to that for the video service, and details are not described herein again.

A possible case is that, for the voice service, the percentage y2 of the predicted result of the random forest model in the total predicted result value is greater than the percentage x2 of the predicted result of the SVM model in the total predicted result value, and x2 is greater than the percentage z2 of the predicted result of the logistic regression model in the total predicted result value. That is, for the voice service, the weight coefficient of the random forest model prediction result in the target predictive model is the greatest.

3. The analysis apparatus generates a predictive model for a multimedia service.

The analysis apparatus first determines a network KPI parameter, and obtains a KQI result of the KPI parameter for the voice service. A large quantity of KPI parameters and KQI results are obtained by repetitively performing this block. Therefore, an association relationship between the KPI parameter and the KQI result is found, and an algorithm formula of the predictive model is determined. It is obtained that the parameters X=x3, Y=y3, and Z=z3. A determining process of the parameters in the algorithm formula of the predictive model is similar to that for the video service, and details are not described herein again.

A possible case is that, for the multimedia service, the percentage z3 of the predicted result of the logistic regression model in the total predicted result value is greater than the percentage y3 of the predicted result of the random forest model in the total predicted result value, and y3 is greater than the percentage x3 of the predicted result of the SVM model in the total predicted result value. That is, for the multimedia service, the weight coefficient of the logistic regression model prediction result in the target predictive model is the greatest.

505. Add the target predictive model to a predictive model set.

506. Obtain to-be-predicted data of the service.

507. Determine, based on a type identifier, the target predictive model in the predictive model set.

508. Determine, based on the target predictive model and a KPI in the to-be-predicted data, a key quality indicator KQI of the service.

In this embodiment, embodiment block 506 to block 508 are similar to embodiment block 201 to block 203 shown in FIG. 2a, and details are not specifically described herein again.

In this embodiment, in the training process of the target predictive model, besides the algorithm formulas of the SVM model, the random forest model, and the logistic regression model, the weight coefficients of the three types of models in the target predictive model further should be determined. A specific training process for the target predictive model is described in this embodiment, to increase feasibility of the solution.

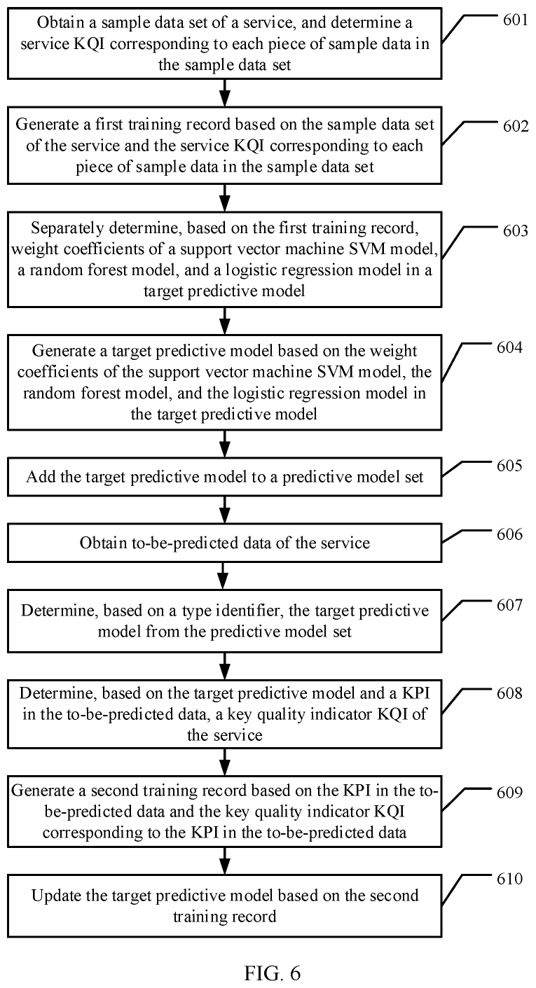

In this embodiment, after the target predictive model is generated, a to-be-predicted KPI can be obtained, a predicted KQI result can be determined, and the to-be-predicted KPI and the predicted KQI result can be recorded. Subsequently, the KPI and the KQI result are used to update the target predictive model and adjust the parameter of the target predictive model. All subsequent KPI parameters and predicted KQI result values that are inputted into the target predictive model can be used to update the target predictive model, to make the predictive model more accurate through repetitive training. Referring to FIG. 6, FIG. 6 is described below.

601. Obtain a sample data set of a service, and determine a service KQI corresponding to each piece of sample data in the sample data set.

602. Generate a first training record based on the sample data set of the service and the service KQI corresponding to each piece of sample data in the sample data set.

603. Separately determine, based on the first training record, weight coefficients of a support vector machine SVM model, a random forest model, and a logistic regression model in a target predictive model.

604. Generate the target predictive model based on the weight coefficients of the support vector machine SVM model, the random forest model, and the logistic regression model in the target predictive model.

605. Add the target predictive model to a predictive model set.

606. Obtain to-be-predicted data of the service.

607. Determine, based on a type identifier, the target predictive model in the predictive model set.

608. Determine, based on the target predictive model and a KPI, a key quality indicator KQI of the service.

609. Generate a second training record of a KPI in the to-be-predicted data and a key quality indicator KQI corresponding to the KPI in the to-be-predicted data.

Because of insufficient sample data volume or another uncontrollable factor, a model obtained through training is not necessarily completely accurate, and there is a high probability that a KQI result obtained by substituting KPI data into the predictive model has a deviation from a theoretical KQI result of the predictive model. Using coin flipping as an example, after flipping a coin for a plurality of times, a probability of heading up is 40 percent through calculation. However, in a subsequent process of flipping the coin repeatedly, it is found that the probability of heading up is not necessarily 40 percent. Therefore, a subsequent actual experiment result can be combined with the result of the predictive model, to adjust the predictive model. In this disclosure, an obtained theoretical KQI result of the predictive model may be good, but an actual KQI result of the to-be-predicted data is medium. Therefore, an analysis apparatus should record KPI data in the to-be-predicted data and a KQI result generated after substituting the KPI data into the predictive model, generate the second training record, place the training record into a storage space, and subsequently adjust the parameter based on an actual KQI result.

610. Update the target predictive model based on the second training record.

When the recorded second training record reaches a specific amount of data, the second training record is reused as the sample data, and is substituted into an existing target predictive model, to adjust an algorithm parameter of the target predictive model with reference to the actual KQI result of the to-be-predicted data, that is, a process of updating the target predictive model, so that the target predictive model is more accurate.

For example, in the process of updating the prediction model, a volume of sample data with KQI results poor is 50, and volumes of sample data with KQI results good and medium are both 200. However, the predictive model may need more low KQI values as the training record, and subsequently, when the predictive model is used, the predicted result is obtained by inputting the to-be-predicted data. For example, a data volume of to-be-predicted data is 10000, a data volume of low KQIs is 5000, and there are a relatively large quantity of low KQI values in the to-be-predicted data. Therefore, the analysis apparatus can retrain the predictive model by using the to-be-predicted data as the sample, adjust the parameters of the predictive model with reference to the KQI results corresponding to the to-be-predicted KPI in an actual case, and generate a new predictive model, that is, a process of optimizing the predictive model. In this case, model training can be performed by using the sample data, and the to-be-predicted 10000 pieces of data with reference to the previous 450 pieces of sample data.

In this embodiment, a process in which the to-be-predicted data is reversed as the sample data to update the target predictive model is described, to increase flexibility of solution implementation.

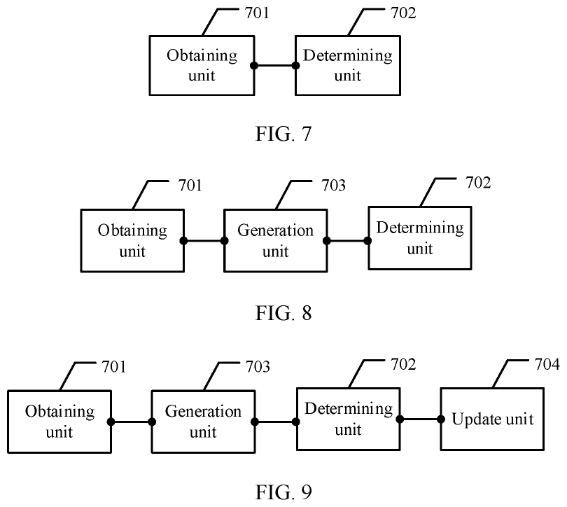

FIG. 2a, FIG. 5 and FIG. 6 describe the indicator determining method of the embodiments of this disclosure. Referring to FIG. 7, an analysis apparatus in this embodiment of this disclosure is described below.

In this embodiment of this disclosure, the analysis apparatus includes:

an obtaining unit 701, configured to obtain to-be-predicted data of a service, where the to-be-predicted data includes a key performance indicator KPI of a network in which the service is located and a type identifier of the service, and the type identifier is used to indicate a type of the service; and

a determining unit 702, configured to determine, based on the type identifier, a target predictive model in a predictive model set, where the predictive model set includes at least one predictive model, each predictive model in the predictive model set corresponds to one service type, and

the determining unit 702 is further configured to determine, based on the target predictive model and the KPI in the to-be-predicted data, a key quality indicator KQI of the service.

In this embodiment, when the KQI of the service is predicted by using the network KPI parameter, it is considered that services of different service types have different predictive models, so that a KQI result of the service predicted by using the network KPI parameter is more accurate.

In an embodiment of this disclosure, as shown in FIG. 8, the analysis apparatus further includes a generation unit 703, and the generation unit 703 is described below.

The obtaining unit 701 is further configured to obtain a sample data set of the service, where the sample data set includes at least one piece of sample data, and each piece of sample data in the sample data set includes the KPI of the network in which the service is located.

The generation unit 703 is configured to: determine a service KQI corresponding to each piece of sample data in the sample data set, generate a first training record based on the sample data set of the service and the service KQI corresponding to each piece of sample data in the sample data set, generate the target predictive model based on the first training record, and add the target predictive model to the predictive model set.

In an implementation, when generating the target predictive model based on the first training record, the generation unit 703 is configured to:

separately determine, based on the first training record, weight coefficients of a support vector machine SVM model, a random forest model, and a logistic regression model in the target predictive model; and

generate the target predictive model based on the weight coefficients of the support vector machine SVM model, the random forest model, and the logistic regression model in the target predictive model.

In this embodiment, a determining process for the target predictive model is described, to increase feasibility of the solution.

In this embodiment, the to-be-predicted data may further be inputted into the target predictive model again as sample data, to adjust a parameter and optimize the target predictive model. In this case, referring to FIG. 9, the analysis apparatus further includes an update unit 704.

The generation unit 703 is further configured to generate a second training record of the KPI in the to-be-predicted data and the key quality indicator KQI corresponding to the KPI in the to-be-predicted data.

The update unit 704 is configured to update the target predictive model based on the second training record.

In this embodiment, the analysis apparatus may adjust the parameter based on the second training record with reference to an actual KQI result of the to-be-predicted data, to optimize the predictive model.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this disclosure, it should be understood that the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this disclosure essentially, or the part contributing to the prior art, or all or some of the technical solutions may be implemented in the form of a software product. The software product is stored in a storage medium and includes several instructions for instructing a computer device (which may be a personal computer, a local client, or a network device) to perform all or some of the blocks of the methods described in the embodiments of FIG. 2a, FIG. 2b, FIG. 5 and FIG. 6 in this disclosure. The foregoing storage medium includes: any medium that can store program code, such as a USB flash drive, a removable hard disk, a read-only memory (ROM), a random access memory (RAM), a magnetic disk, or an optical disc.

The foregoing embodiments are merely intended for describing the technical solutions of this disclosure, but not for limiting this disclosure. Although this disclosure is described in detail with reference to the foregoing embodiments, persons of ordinary skill in the art should understand that they may still make modifications to the technical solutions described in the foregoing embodiments or make equivalent replacements to some technical features thereof without departing from the scope of the technical solutions of the embodiments of this disclosure.

1. A method, comprising:
obtaining to-be-predicted data of a service, wherein the to-be-predicted data comprises a key performance indicator (KPI) of a network in which the service is located and a type identifier of the service, and the type identifier is indicative of a type of the service;
determining, based on the type identifier, a target predictive model in a predictive model set, wherein the predictive model set comprises at least one predictive model, and each predictive model in the predictive model set corresponds to one service type; and
determining, based on the target predictive model and the KPI in the to-be-predicted data, a key quality indicator (KQI) of the service.

2. The method of claim 1, wherein before determining the target predictive model in the predictive model set, the method further comprises:
obtaining a sample data set of the service, wherein the sample data set comprises at least one piece of sample data, and each piece of sample data in the sample data set comprises the KPI of the network in which the service is located;
determining a service KQI corresponding to each piece of sample data in the sample data set;
generating a first training record based on the sample data set of the service and the service KQI corresponding to each piece of sample data in the sample data set;
generating the target predictive model based on the first training record; and
adding the target predictive model to the predictive model set.

3. The method of claim 2, wherein generating the target predictive model based on the first training record comprises:
determining, based on the first training record, one or more of weight coefficients of a support vector machine SVM model, a random forest model, and a logistic regression model in the target predictive model; and
generating the target predictive model based on one or more of the weight coefficients of the support vector machine SVM model, the random forest model, and the logistic regression model in the target predictive model.

4. The method of claim 2, wherein the sample data set comprises first sample data, second sample data, and third sample data, a first KQI corresponding to the first sample data is less than a second KQI corresponding to the second sample data, the second KQI corresponding to the second sample data is less than a third KQI corresponding to the third sample data, and data volumes of the first sample data, the second sample data and the third sample data are equal.

5. The method of claim 2, wherein the sample data set comprises fourth sample data, and a fourth KQI corresponding to the fourth sample data is less than a preset KQI threshold.

6. The method of claim 3, wherein the weight coefficients of the SVM model, the random forest model, and the logistic regression model in the target predictive model are respectively X, Y and Z, and a result value Q predicted by the target predictive model=X*a result value predicted by the SVM model+Y*a result value predicted by the random forest model+Z*a result value predicted by the logistic regression model.

7. The method of claim 6, wherein the type of the service is a video service, the result value Q predicted by the target predictive model=x1*the result value predicted by the SVM model+y1*the result value predicted by the random forest model+z1*the result value predicted by the logistic regression model, and x1>y1>z1.

8. The method of claim 6, wherein the type of the service is a voice service, the result value Q predicted by the target predictive model=x2*the result value predicted by the SVM model+y2*the result value predicted by the random forest model+z2*the result value predicted by the logistic regression model, and y2>x2>z2.

9. The method of claim 6, wherein the type of the service is a multimedia service, the result value Q predicted by the target predictive model=x3*the result value predicted by the SVM model+y3*the result value predicted by the random forest model+z3*the result value predicted by the logistic regression model, and z3>y3>x3.

10. The method of claim 2, wherein after determining the key quality indicator KQI of the service, the method further comprises:
generating a second training record of the KPI in the to-be-predicted data and the key quality indicator KQI corresponding to the KPI in the to-be-predicted data; and
updating the target predictive model based on the second training record.

11. An apparatus, comprising a processor and a memory, wherein
the memory is to store program code; and
the processor is to execute the program code in the memory, to implement the following method:
obtaining to-be-predicted data of a service, wherein the to-be-predicted data comprises a key performance indicator (KPI) of a network in which the service is located and a type identifier of the service, and the type identifier is indicative of a type of the service;
determining, based on the type identifier, a target predictive model in a predictive model set, wherein the predictive model set comprises at least one predictive model, and each predictive model in the predictive model set corresponds to one service type; and
determining, based on the target predictive model and the KPI in the to-be-predicted data, a key quality indicator (KQI) of the service.

12. The apparatus of claim 11, wherein before determining the target predictive model in the predictive model set, the method further comprises:
obtaining a sample data set of the service, wherein the sample data set comprises at least one piece of sample data, and each piece of sample data in the sample data set comprises the KPI of the network in which the service is located;
determining a service KQI corresponding to each piece of sample data in the sample data set;
generating a first training record based on the sample data set of the service and the service KQI corresponding to each piece of sample data in the sample data set;
generating the target predictive model based on the first training record; and
adding the target predictive model to the predictive model set.

13. The apparatus of claim 12, wherein generating the target predictive model based on the first training record comprises:
separately determining, based on the first training record, one or more of weight coefficients of a support vector machine SVM model, a random forest model, and a logistic regression model in the target predictive model; and
generating the target predictive model based on one or more of the weight coefficients of the support vector machine SVM model, the random forest model, and the logistic regression model in the target predictive model.

14. The apparatus of claim 12, wherein the sample data set comprises first sample data, second sample data, and third sample data, a first KQI corresponding to the first sample data is less than a second KQI corresponding to the second sample data, the second KQI corresponding to the second sample data is less than a third KQI corresponding to the third sample data, and data volumes of the first sample data, the second sample data and the third sample data are equal.

15. The apparatus of claim 12, wherein the sample data set comprises fourth sample data, and a fourth KQI corresponding to the fourth sample data is less than a preset KQI threshold.

16. The apparatus of claim 13, wherein the weight coefficients of the SVM model, the random forest model, and the logistic regression model in the target predictive model are respectively X, Y and Z, and a result value Q predicted by the target predictive model=X*a result value predicted by the SVM model+Y*a result value predicted by the random forest model+Z*a result value predicted by the logistic regression model.

17. The apparatus of claim 16, wherein the type of the service is a video service, the result value Q predicted by the target predictive model=x1*the result value predicted by the SVM model+y1*the result value predicted by the random forest model+z1*the result value predicted by the logistic regression model, and x1>y1>z1.

18. The apparatus of claim 16, wherein the type of the service is a voice service, the result value Q predicted by the target predictive model=x2*the result value predicted by the SVM model+y2*the result value predicted by the random forest model+z2*the result value predicted by the logistic regression model, and y2>x2>z2.

19. The apparatus of claim 16, wherein the type of the service is a multimedia service, the result value Q predicted by the target predictive model=x3*the result value predicted by the SVM model+y3*the result value predicted by the random forest model+z3*the result value predicted by the logistic regression model, and z3>y3>x3.

20. The apparatus of claim 12, wherein after the determining the key quality indicator KQI of the service, the method further comprises:
generating a second training record of the KPI in the to-be-predicted data and the key quality indicator KQI corresponding to the KPI in the to-be-predicted data; and
updating the target predictive model based on the second training record.
